(19) United States
(12) Patent Application Publication
(10) Pub. No.: US 2008/0037904 A1
(43) Pub. Date: Feb. 14, 2008

(54) Apparatus, method and program storage medium for image interpretation

(75) Inventors: Michiyo Hiramoto, Saitama (JP); Yoshinori Ohkuma, Saitama (JP); Shinichi Murata, Aichi (JP)

Correspondence Address: RABIN & Berdo, PC, 1101 14TH STREET, NW, SUITE 500, WASHINGTON, DC, 20005, US

(73) Assignee: OKI ELECTRIC INDUSTRY CO., LTD., Tokyo (JP)

(21) Appl. No.: 11/826,467

(22) Filed: Jul. 16, 2007

(30) Foreign Application Priority Data
Aug. 14, 2006 (JP) 2006-221215

(51) Int. Cl. G06K 9/60; G06K 9/66

(52) U.S. Cl. 382/306; 382/195; 382/305

(57) ABSTRACT

An image interpretation apparatus including a registration section, an image search section, and an image interpretation section is provided. The registration section registers an object image in an object database. The image search section searches a type, an attribute, and an arrangement, or a combination of the object images included in an input image. The image interpretation section interprets semantics of the input image based on the arrangement, the combination, or the like. Due to this configuration, plural pieces of semantics can be given to a single image, and a complex subsequent-stage process can be performed according to an image interpretation result.

### CROSS-REFERENCE TO RELATED APPLICATION

This application claims priority under 35 USC 119 from Japanese Patent Application No. 2006-221215, the disclosure of which is incorporated by reference herein.

### BACKGROUND OF THE INVENTION

1. Field of the Invention

The present invention relates to an apparatus and a method for image interpretation and a storage medium in which a program for image interpretation is stored.

2. Description of the Related Art

Recently, performance of an information processing apparatus is remarkably improved so that a large amount of information can be processed at high speed. A database system in which plural pieces of information are correlated with one another becomes dramatically widespread with the remarkable improvement of the information processing apparatus, and various databases are now utilized even in a personal computer for home use. For example, these databases are utilized for address list management, schedule management, music data management, image information management, and the like.

However, the conventional database is generally used for sorting or retrieving, based on a search condition, the various pieces of information correlated with key information which becomes a key for search. The conventional database is also used in a developed form for searching an image using a registered image and the key information assigned to the image. For example, in an image search technique disclosed in Japanese Patent Application Laid-Open (JP-A) No. 2002-245048, based on image data inputted as search information, key information is found out from a feature (characteristic) of the input image data, and an image identical or similar to the input image data is found from images registered in a database.

According to the above image search technique, the image registered in the database is divided into plural rectangular regions to extract color/gray histogram information, texture information and the like as the feature for each divided rectangular region, and is registered in the database along with the feature. Similarly, for the input image, the similar feature is detected, and an image identical or similar to the input image is retrieved from the images registered in the database based on the feature. Although it is also useful to retrieve the image itself, by correlating various pieces of information with the registered image, information associated with the input image can be searched using this technique.

However, in the conventional image search technique as described above, although the image information is retrieved for each divided region, the feature obtained from the whole input image is referred to search an identical or similar image from the images registered in the database. Therefore, it is difficult to search information based on a correlation between object images included in the input image or a correlation between the input image and the object image. Since semantics cannot be given to the correlation between the object images, an information amount which can be added to one image is restricted, and a range of the information search in which an image is used as key information is narrowed. Furthermore, it is impossible to assign a grammatical rule to a correlation among plural object images to realize a relational function among the object images.

That is, in the conventional method, due to the restriction of “one search key for one image”, plural images are required to perform a search with plural keywords. Therefore, development of a technique of giving “plural search keys to one image” is demanded.

In view of the foregoing, present invention is to provide image interpretation apparatus and method in which semantics of an input image can be interpreted according to an arrangement or combination of object images included in the input image, and a storage medium in which a program for the image interpretation is stored.

### SUMMARY OF THE INVENTION

A first aspect of the invention provides an image interpretation apparatus including: a registration image information storage section which includes an object database in which an object image expressing a single object, at least one feature being able to specify a type of the object image, and semantic information corresponding to the object image are registered in correlation with one another; an image obtaining section which obtains an input image to be a subject of interpretation of semantics; an object image extraction section which scans the input image to detect its features, detects the registered object image included in the input image and retrieves the semantic information corresponding to the object image; an arrangement information obtaining section which obtains arrangement information indicating a relationship between the input image and the object image; a grammatical rule information storage section which includes a grammatical rule database in which at least one grammatical rule is registered for adding additional semantics to the input image corresponding to the relationship between the input image and the object image; and an image interpretation section which retrieves the at least one grammatical rule based on the arrangement information, and interprets the semantics of the input image based on the semantic information on the object image and the at least one grammatical rule.

According to the configuration of the first aspect, semantics can be given to the arrangement of the object image included in one input image, and the plural pieces of semantics can be given to the input image.

The first aspect of the invention may be configured such that the arrangement information includes positional information indicating a position of each object image in the input image; the at least one grammatical rule is a rule for selecting a single piece of semantic information from the semantic information corresponding to the object image, according to the positional information; and the image interpretation section interprets the semantic information of the object image selected according to the at least one grammatical rule, as the semantics of the input image.

According to the above configuration, the semantics of the input image can be interpreted based on the position of the object image.

The first aspect of the invention may be configured such that the arrangement information includes morphological information on a size and/or a gradient of the object image; the at least one grammatical rule defines a method of computing an evaluation value, the parameters of which are based on the morphological information; and the image interpretation section interprets the semantics of the input image by adding the evaluation value computed according to the at least one grammatical rule.

According to the above configuration, the semantics of the input image can be interpreted based on the morphology of the object image.

The first aspect of the invention may configured such that the arrangement information obtaining section includes a combination information obtaining section which, when a plurality of object images are extracted by the object image extraction section, further obtains combination information indicating a relationship between one of the extracted object images and the other extracted object images, the grammatical rule information storage section includes a combination rule information storage section which includes a combination rule database in which at least one grammatical rule is registered for adding additional semantics to the input image corresponding to the relationship between the object images, and the image interpretation section retrieves the at least one grammatical rule based on the arrangement information and the combination information, and interprets the semantics of the input image based on the semantic information of the object image and the at least one grammatical rule.

According to the above configuration, the semantics of the input image can be interpreted according to the arrangement of the object images and the combination between the object images, and plural pieces of more complex semantics can be given to the input image.

The first aspect of the invention may be configured such that the arrangement information includes at least one of: (a) positional information indicating a position of each object image in the input image, (b) combination information indicating, when a plurality of object images are extracted, a relationship between one of the extracted object images and the other extracted object images, and (c) missing information on a missing region of the extracted object image.

According to the above configuration, the semantics of the input image can be interpreted according to the position of the object image, the combination between the object images, and/or the missing region of the object image, and plural pieces of semantics can be given to the input image.

The first aspect of the invention may be configured such that the combination information includes positional information indicating a relative positional relationship of the plurality of extracted object images; the at least one grammatical rule defines a joining relationship of the semantic information corresponding to each object image according to the positional information; and the image interpretation section interprets the semantic information on the plurality of object images, which are joined according to the at least one grammatical rule, as the semantics of the input image.

According to the above configuration, the semantics of the input image can be interpreted according to the joining relationship of the object image, and more complex semantics can be given to the input image.

The first aspect of the invention may be configured such that the arrangement information obtaining section includes a missing information obtaining section which detects missing information on a missing region of the extracted object image, the grammatical rule information storage section includes a missing rule information storage section which includes a combination rule database in which at least one grammatical rule is registered for adding additional semantics to the input image based on a missing percentage of the object images; and the image interpretation section retrieves the at least one grammatical rule based on the missing information, and interprets the semantics of the input image based on the semantic information on the object image and the at least one grammatical rule.

According to this configuration, the semantics of the input image can be interpreted according to the missing information on the object image, and plural pieces of semantics can be given to the input image.

The first aspect of the invention may be further configured such that the missing information includes missing area information indicating an area ratio of an area of the detected missing region to an area of the object image; the at least one grammatical rule defines a computation method in which a quantitative value included in the semantic information corresponding to the object image is changed according to the area ratio; and the image interpretation section interprets a quantitative value of the object image, which is computed according to the at least one grammatical rule, as the semantics of the input image.

According to the above configuration, the semantics of the input image can be interpreted based on the missing area ratio of the object image, and more complex semantics can be given to the input image.

A second aspect of the invention provides an image interpretation method including: registering an object image expressing a single object, at least one feature being able to specify a type of the object image, and semantic information corresponding to the object image in an object database, wherein the object image, the at least one feature, and the semantic information are correlated with one another; obtaining an input image to be a subject for interpretation of semantics; scanning the input image to detect its features, and extracting the registered object image included in the input image and the semantic information corresponding to the object image; obtaining arrangement information indicating a relationship between the input image and the object image; registering in an arrangement rule database at least one grammatical rule for adding additional semantics to the input image, corresponding to the relationship between the input image and the object image; and retrieving the at least one grammatical rule based on the arrangement information, and interpreting the semantics of the input image based on the semantic information on the object image and the at least one grammatical rule.

According to this configuration, the semantics of the input image can be interpreted based on the arrangement of the object image, and plural pieces of semantics can be given to the input image.

The second aspect of the invention may further include: extracting a plurality of registered object images included in the input image and the semantic information corresponding to the object images; obtaining combination information indicating a relationship between one of the extracted object images and the other extracted object images; registering in a combination rule database at least one grammatical rule for adding additional semantics to the input image, corresponding to the relationship between the object images; and retrieving the at least one grammatical rule based on the combination information, and interpreting the semantics of the input image based on the semantic information on the object image and the at least one grammatical rule.

According to this configuration, the semantics of the input image can be interpreted based on the relative relationship between the object images, and more complex semantics can be given to the input image.

The second aspect of the invention may further include: detecting missing information on a missing region of the extracted object image; registering in a combination rule database at least one grammatical rule for adding additional semantics to the input image, corresponding to a missing percentage of the object image; and retrieving the at least one grammatical rule based on the missing information, and interpreting the semantics of the input image based on the semantic information on the object image and the at least one grammatical rule.

According to this configuration, the semantics of the input image can be interpreted based on the information on the missing region of the object image, and more complex semantics can be given to the input image.

A third aspect of the invention provides a machine-readable storage medium storing a program for causing a computer to execute an image interpretation process, the process including: registering an object image expressing a single object, at least one feature being able to specify a type of the object image, and semantic information corresponding to the object image in an object database, wherein the object image, the at least one feature, and the semantic information are correlated with one another; obtaining an input image to be a subject for interpretation of semantics; scanning the input image to detect its features, and extracting the registered object image included in the input image and the semantic information corresponding to the object image; obtaining arrangement information indicating a relationship between the input image and the object image; registering in an arrangement rule database at least one grammatical rule for adding additional semantics to the input image, corresponding to the relationship between the input image and the object image; and retrieving the at least one grammatical rule based on the arrangement information, and interpreting the semantics of the input image based on the semantic information on the object image and the at least one grammatical rule.

According to the configuration of the third aspect of the invention, the semantics of the input image can be interpreted based on the arrangement information on the object image, and plural pieces of semantics can be given to the input image.

The process of the third aspect may further include: extracting a plurality of registered object images included in the input image and the semantic information corresponding to the object images; obtaining combination information indicating a relationship between one of the extracted input images and the other extracted object images; registering in a combination rule database at least one grammatical rule for adding additional semantics to the input image, corresponding to the relationship between the object images; and retrieving the at least one grammatical rule based on the combination information, and interpreting the semantics of the input image based on the semantic information on the object image and the at least one grammatical rule.

According to this configuration, the semantics of the input image can be interpreted according to the combination of the object images, and more complex semantics can be given to the input image.

The process of the third aspect may further include: detecting missing information on a missing region of the extracted object image; registering in a combination rule database at least one grammatical rule for adding additional semantics to the input image, corresponding to a missing percentage of the object image; and retrieving the at least one grammatical rule based on the missing information, and interpreting the semantics of the input image based on the semantic information on the object image and the at least one grammatical rule.

According to this configuration, the semantics of the input image can be interpreted based on the missing information on the object image, and more complex semantics can be given to the input image.

As described above, according to the invention, the semantics of the input image can be interpreted according to the arrangement or combination of the object images included in the input image.

### BRIEF DESCRIPTION OF THE DRAWINGS

Exemplary embodiments of the present invention will be described in detail based on the following figures, wherein:

FIG. 1 is a block diagram showing a configuration of an image interpretation apparatus according to a first embodiment of the invention;

FIG. 2 is a flowchart showing a process of registering data in an object database according to the first embodiment;

FIG. 3 is a flowchart showing an image interpretation process according to the first embodiment;

FIG. 4 is an explanatory view showing an exemplary configuration of the object database according to the first embodiment;

FIG. 5 is an explanatory view showing arrangement rules of the object image according to the first embodiment;

FIG. 6 is an explanatory view showing an exemplary configuration of an arrangement rule database according to the first embodiment;

FIG. 7 is an explanatory view showing a specific example of the image interpretation process according to the first embodiment;

FIG. 8 is a block diagram showing a configuration of an image interpretation apparatus according to a second embodiment of the invention;

FIG. 9 is an explanatory view showing combination rule of object images according to the second embodiment;

FIG. 10 is an explanatory view showing an exemplary configuration of an object database according to the second embodiment;

FIG. 11 is an explanatory view showing an exemplary configuration of a combination rule database according to the second embodiment;

FIG. 12 is an explanatory view showing a specific example of an image interpretation process according to the second embodiment;

FIG. 13 is an explanatory view showing a specific example of the image interpretation process according to the second embodiment;

FIG. 14 is an explanatory view showing a specific example of the image interpretation process according to the second embodiment;

FIG. 15 is a block diagram showing a configuration of an image interpretation apparatus according to a third embodiment of the invention;

FIG. 16 is an explanatory view showing an exemplary configuration of an arrangement database and a combination rule database according to the third embodiment;

FIG. 17 is an explanatory view showing a specific example of an image interpretation process according to the third embodiment;

FIG. 18 is a block diagram showing a configuration of an image interpretation apparatus according to a fourth embodiment of the invention;

FIG. 19 is an explanatory view showing a missing rule of object images according to the fourth embodiment;

FIG. 20 is an explanatory view showing an exemplary configuration of an object database according to the fourth embodiment;

FIG. 21 is an explanatory view showing an exemplary configuration of a missing rule database according to the fourth embodiment; and

FIG. 22 is an explanatory view showing a specific example of an image interpretation process according to the fourth embodiment.

### DETAILED DESCRIPTION OF THE INVENTION

Exemplary embodiments of the present invention will be described in detail below with reference to the accompanying drawings. In the description and drawings, the component having substantially the same function and configuration is designated by the same numeral, and repeated description is omitted.

### First Embodiment

An image interpretation apparatus and an image interpretation method according to a first embodiment of the invention will be described below.

(Configuration of Image Interpretation Apparatus)

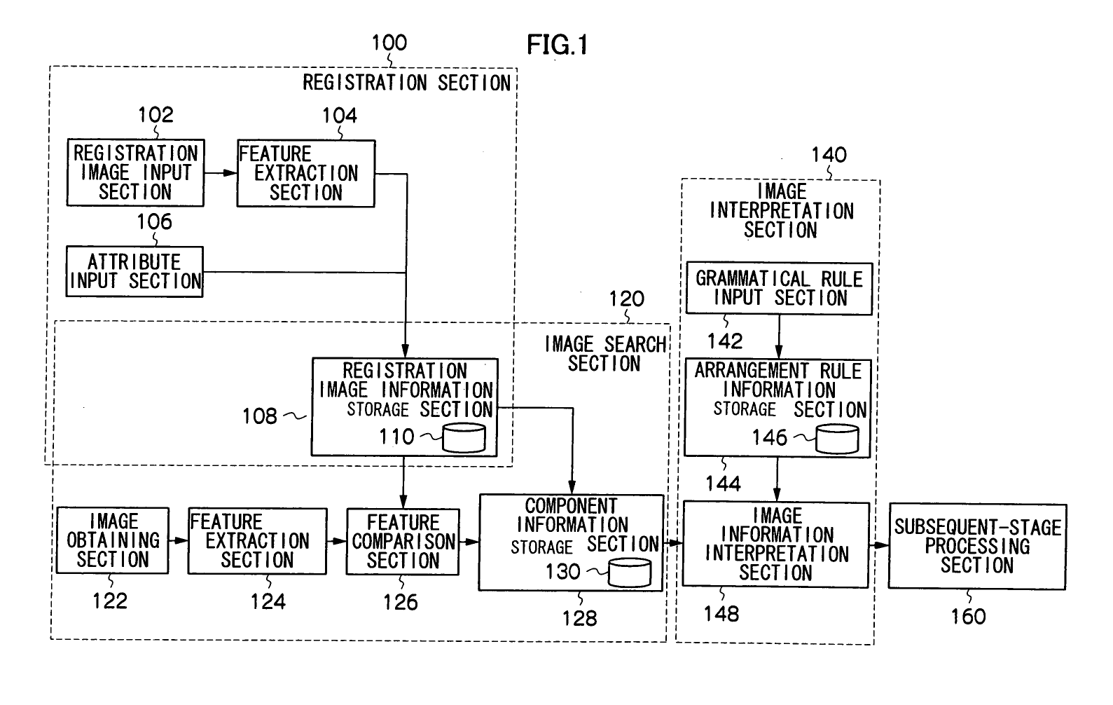

A configuration of the image interpretation apparatus of the first embodiment will be described in detail below with reference to FIG. 1.

The image interpretation apparatus of the first embodiment includes a registration section 100, an image search section 120, an image interpretation section 140, and a subsequent-stage processing section 160. Although not shown in the drawings, a function of each section, which will be described below, may be realized by hardware such as a storage device and CPU which are included in a computer,

(Registration Section 100)

The registration section 100 includes a registration image input section 102, a feature (characteristic) extraction section 104, an attribute input section 106, and a registration image information storage section 108. The registration section 100 is used to register image data of an object image which is necessary to interpret an image input by a user, and various pieces of information correlated with the object image.

As used herein, the object image may be, for example, an image for expressing a single object, and specifically an image for expressing a single substance or scene. Obviously the object image may be a single character, a character string, or an image set having a common abstract or conceptual feature. The various pieces of information may be semantics, a shape, a color, a name, and/or other information of the object image to be registered. A user can register various pieces of information according to a utilization mode of the image interpretation apparatus. Therefore, information which is not directly or indirectly related with an object expressed in the object image to be registered may be registered while being intentionally correlated with the object.

The registration image input section 102 is used to input the object image to be registered. The registration image input section 102 may be a keyboard, a mouse, a touch pen, an image scanner, a digital camera, and/or other input units, and further may be an image processing program and/or a drawing program which runs in conjunction with such input sections. The registration image input section 102 may also be an apparatus or a program for automatically or manually downloading the object image from a database server or the like (not shown) connected to a network.

Using an edge filter or the like, the feature extraction section 104 extracts at least one feature (characteristic) from the object image inputted by the registration image input section 102. For example, the feature extraction section 104 may scan brightness or a gradation level of the object image to detect a characteristic highlight portion or an outline portion of the object image. When the feature is detected, the feature extraction section 104 transmits the feature extracted from the object image together with the object image to the registration image information storage section 108, which is described later.

The attribute input section 106 is an input unit for inputting at least one attribute of the object image inputted by the registration image input section 102, and to be registered while correlated with the object image. The attribute input section 106 may be a keyboard, a mouse, and/or an information processing program which runs in conjunction with such input units. The attribute input section 106 transmits the inputted attribute information to the registration image information storage section 108. The attribute information may be, for example, semantics, a shape, a color, a name, and/or other information of an object expressed by the object image. The other information may include information which is not directly or indirectly correlated with the object expressed in the object image to be registered. For example, the other information may be a name of a person who is not related with the object image, numerical information such as an amount of money, and/or a place-name which are not related with the object image. Any piece of attribute information can be inputted according to the utilization mode of the image interpretation apparatus. The attribute input section 106 may also be, for example, an apparatus or a program for automatically or manually downloading the attribute information related with the object image from a database server or the like (not shown) connected to a network.

The registration image information storage section 108 includes an object database 110, in which registered are the object image inputted by the registration image input section 102, the feature of the object image extracted by the feature extraction section 104, and the attribute information of the object image inputted by the attribute input section 106. The registration image information storage section 108 can register various pieces of information including the object image, the feature, and the attribute information in the object database 110 in correlation with each other, and can also retrieve other related information using one or more pieces of information included in the various pieces of information as key information. Although the registration image information storage section 108 is described to be included in the registration section 100, the registration image information storage section 108 can be also referred from the image search section 120 described later, and therefore it may be considered being also included in the image search section 120.

(Image Search Section 120)

The image search section 120 includes an image obtaining section 122, a feature extraction section 124, a feature (characteristic) comparison section 126, and a component information storage section 128. As described above, the registration image information storage section 108 may be also included as a component. The image search section 120 searches the object image, which is registered in the object database 110, from the input image.

The image obtaining section 122 is an input unit for inputting an image which the user requires interpretation. The image obtaining section 122 may be, for example, a keyboard, a mouse, a touch pen, an image scanner, a digital camera, and/or other input sections, and further may be an image processing program or a drawing program which runs in conjunction with such input units. Hereinafter, “the image which the user asks requires interpretation” is referred to as “input image”. The input image may be any image including one or more object images, and may be, for example, a photograph, a character, a graphic, a diagram, and the like.

Using an edge filter or the like, the feature extraction section 124 extracts at least one feature from the input image inputted by the image obtaining section 122. For example, the feature extraction section 124 can scan the brightness or gradation level of the object image to detect the characteristic highlight portion or outline portion of the input image. When the feature is detected, the feature extraction section 124 transmits the feature extracted from the input image together with the input image to the feature comparison section 126 which will be described later.

The feature comparison section 126 retrieves the object image having at least one feature identical with or similar to that of the input image from the object database 110. As described above, one or more object images and the feature of each object image are registered in the object database 110. The feature comparison section 126 detects the features identical with or similar to that of the object image from among the features of the input image. Further, the feature comparison section 126 transmits detection information obtained by detecting the object image to the component information storage section 128. The detection information may include, for example, a detected position of the object image included in the input image is detected, a size of the object image, and a matching rate between the detected object image and the registered object image. That is, the feature comparison section 126 is one example of the object image extraction section and the arrangement information obtaining section.

The component information storage section 128 includes a component database 130, and registers the object images detected by the feature comparison section 126, attribute information related with each of the object images, and the detection information obtained in the detection by the component database 130. At this time, the component information storage section 128 refers to the object database 110 to retrieve the attribute information for each of the detected object images. The component information storage section 128 registers the object image, the attribute information, the detection information, and/or other information in the component database 130 with mutual correlation with each other such that each piece of information can be used as key information for retrieving the other information.

(Image Interpretation Section 140)

The image interpretation section 140 includes a grammatical rule input section 142, an arrangement rule information storage section 144, and an image information interpretation section 148. On the basis of the information on the input image retrieved by the image search section 120, the image interpretation section 140 interprets the semantics expressed by the input image according to at least one grammatical rule set in advance.

The grammatical rule input section 142 is an input unit for inputting semantic information which is given to morphology of the object image included in the input image. Particularly, because the first embodiment is characterized in that the semantics is given to the arrangement of the object image, the grammatical rule input section 142 is an input unit for inputting semantic information corresponding to the arrangement of the object image in the input image. The grammatical rule input section 142 may be a keyboard and/or a mouse. The grammatical rule input section 142 may also be an apparatus or a program for automatically or manually downloading arrangement information and semantic information related with the arrangement information from a database server or the like (not shown) connected to a network.

The arrangement information may include, for example, a position (vertical or horizontal) of the object image in the input image, a size of the object image (large or small, or an area proportion of the object image to the input image), a rotation angle (gradient), and/or a horizontal to vertical ratio. The semantic information may include, for example, information such as “which piece of attribute information registered in the object database 110 is selected (selection of item)?”, “what is a level of importance?”, and/or “what is a degree of satisfaction?” Thus, at least one rule which defines semantic information according to the morphology of the object image relative to the input image is referred to as “grammatical rule”. When the grammatical rule is inputted, the grammatical rule input section 142 transmits the inputted grammatical rule to the arrangement rule information storage section 144.

The arrangement rule information storage section 144 includes an arrangement rule database 146, and registers the grammatical rule inputted by the grammatical rule input section 142 in the arrangement rule database 146. At this time, the arrangement rule information storage section 144 registers the arrangement information on the object image and the semantic information corresponding to the object image in the arrangement rule database 146 in correlation with each other.

The image information interpretation section 148 may refer to the component database 130 and the arrangement rule database 146 to interpret the semantic information on the input image based on the arrangement information on the object image included in the input image. As described above, the object image included in the input image and the attribute information and the detection information on the object image are registered in the component database 130. On the other hand, the arrangement information on the object image and the semantic information correlated with the arrangement information are registered in the arrangement rule database 146. Therefore, the image information interpretation section 148 collates the detection information on the object image with the arrangement information to retrieve the semantic information corresponding to the object image. The image information interpretation section 148 can retrieve desired information from the attribute information on the object image based on the retrieved semantic information. When plural pieces of arrangement information correspond to the object image, the image information interpretation section 148 retrieves plural pieces of information included in the attribute information, based on the semantic information corresponding to each of the plural pieces of arrangement information, to obtain an interpretation result by a combination of the plural pieces of information. After the interpretation result is obtained, the image information interpretation section 148 transmits the interpretation result to the subsequent-stage processing section 160.

(Subsequent-Stage Processing Section 160)

The subsequent-stage processing section 160 may be an output unit which outputs the interpretation result outputted by the image information interpretation section 148 and/or a storage unit in which the interpretation result is stored. The output unit may be, for example, a display device and/or an audio output section. The storage unit may be, for example, a magnetic storage device and/or an optical storage device.

Thus, the configuration of the image interpretation apparatus of the first embodiment is described in detail with reference to FIG. 1. Hereinafter, an image interpretation method utilizing the image interpretation apparatus will be described in detail while the image interpretation method is divided into a registration procedure and an interpretation procedure.

(Image Interpretation Method)

An object image registration procedure, an arrangement rule registration procedure, and an input image interpretation procedure of the image interpretation method of the first embodiment will be described in detail with reference to the drawings.

(Object Image Registration Procedure)

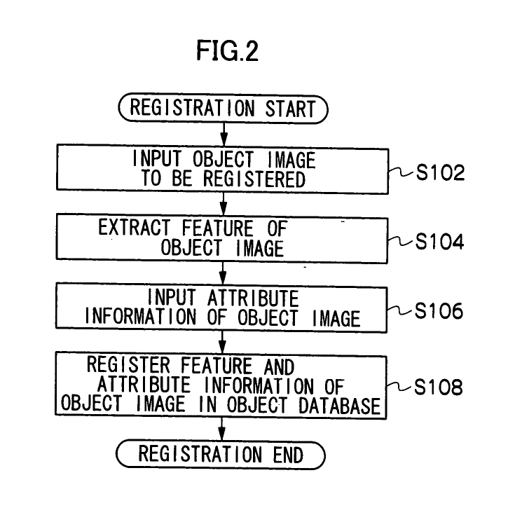

The registration procedure in the image processing method of the first embodiment will be described in detail with reference to FIG. 2. FIG. 2 is a flowchart showing the registration procedure.

A user inputs an object image produced with a digital camera, an image producing tool or the like (registration image input section 102) (S102). The object image may be, for example, a photograph, an illustration, a graphic, a logo, and/or a handwritten picture.

When the object image is inputted, the feature extraction section 104 extracts at least one specific feature of the object image using an image processing filter or the like (S104). The features may be, for example, edge intensity and/or an edge position. A wavelet filter, for example, can be used as the image processing filter.

Then, the user inputs attribute information to be related with the object information through the attribute input section 106 (S106). The attribute information may for example, semantics, shape, color, and/or name of the object image.

When the object image and the attribute information thereon are inputted, the object image, the extracted feature, and the inputted attribute information are correlated with each other and registered in the object database 110 included in the registration image information storage section 108 (S108).

Due to the above registration procedure, the user can register the object image desired to be utilized for the image interpretation and the attribute information on the object image in the object database 110, and also can retrieve the information associated with the object image with reference to the object database 110 during the image interpretation.

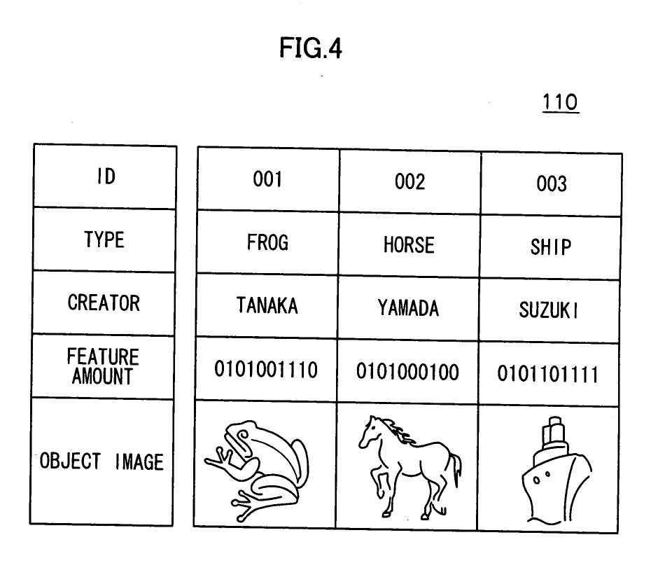

Here, a specific configuration of the object database 110 will briefly be described with reference to FIG. 4. FIG. 4 is an explanatory view showing a specific example of the object database 110. In FIG. 4, each element is shown in the tabular form in which ID (indicator) is used as an index. However, the form is not limited to that of FIG. 4. Any mode may be employed if the elements are configured to be correlated with each other with respect to a single index.

The object database 110 of FIG. 4 has a data structure in which ID, type, creator, feature amount, and an object image are set as item information.

The index which is uniquely determined with respect to each object image is described in the ID field. The index is an indicator which is sequentially assigned to the object images at the registration thereof. The type of object specifically indicated by the object image is described in the type field. For example, name of the object indicated by the object image, as well as other classification types (such as movable estate, real estate, ship, automobile, airplane, animal, plant, amphibian, reptile, primate, Order Primates, Japanese Macaque, Cercopithecidae, Hominidae, and the like) may be described in the type field. The creator name of an image to which the object image is added is described in the creator field. In other words, a personal name assigned in each object image is described in the creator field. Data (feature amount) obtained by digitizing the features extracted by the feature extraction section 104 is described in the feature amount field. That is, the feature amount is numerical data which is quantified to specify the object image which is image data. The inputted object image is attached as image data in the object image field.

For example, referring to ID field of “001”, “picture of frog” is registered as the object image. “Frog” is registered in the type field, “Tanaka” is registered in the creator field, and numerical data of “0101001110” is registered in the feature amount. These pieces of data are correlated with each other, and the user can use one or more pieces of the data as the key information for searching the other data. Accordingly, it is possible to find the object image based on the feature amount, specify the creator from the object image, and so on.

(Arrangement Rule Registration Procedure)

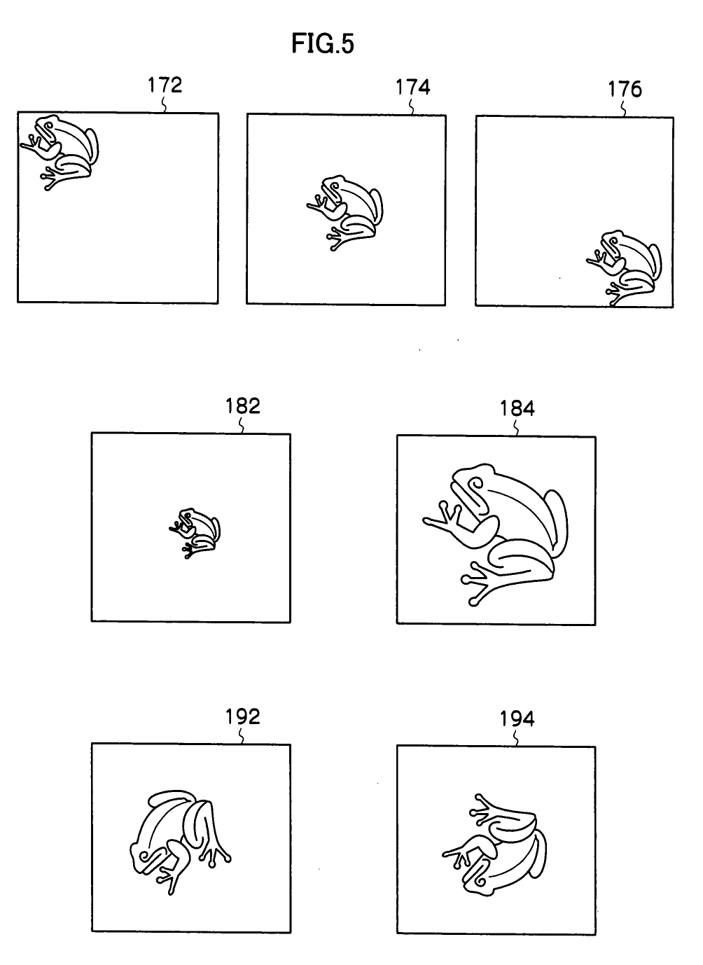

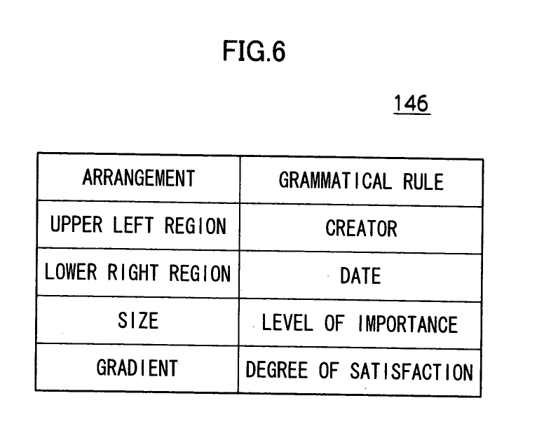

Next, the arrangement rule registration procedure will be specifically described with reference to FIGS. 5 and 6. FIG. 5 is an explanatory view showing specific examples of the object image arrangement rule. FIG. 6 is an explanatory view showing a data structure of the arrangement rule database 146.

First, the arrangement rule will be described with reference to FIG. 5. As used herein, the arrangement rule means a relative relationship of the object image with respect to the input image. The arrangement rule may include, for example, a relative size of the object image to the input image, a position of the object image based on the center of the input image, a rotation angle of the object image to the input image, and the like. The variations of the arrangement rule are not limited to the above examples, and can select any rule as long as the relative relationship of the object image with respect to the input image is quantitatively expressed. Further, the above arrangement rules can also be combined. For example, an expression of “large object image arranged in an upper left portion” can also be adopted as the arrangement rule.

In FIG. 5, reference numerals 172, 174, and 176 are explanatory views showing three specific variations for the object image position based on the center of the input image. A frame line indicates an outer frame of one input image. Reference numeral 172 shows an input image in which the object image (frog) positions in an upper left portion, reference numeral 174 shows an input image in which the object image positions in the center, and reference numeral 176 shows an input image in which the object image positions in a lower right portion. The position recognition of the object image is not limited this rough classification such as upper, lower, left and right, but the position may be recognized by position coordinates based on the center, a corner point or the like of the input image.

The numerals 182 and 184 in FIG. 5 are explanatory views showing two specific variations for the relative size of the object image with respect to the input image. The object image of 182 occupies an area of a half or less of the input image, and thus can be recognized as a small image. On the other hand, the object image of 184 occupies an area of a half or more of the input image, and thus can be recognized as a large image. The determination of the magnitude relation may be made based on other object images included in the input image, or may be made based on a predetermined reference separate from the input image.

Further, the numerals 192 and 194 in FIG. 5 are explanatory views showing two specific variations for the rotation angle of the object image with respect to the input image. The object image of 192 can be recognized as an image which is rotated counterclockwise by 90 degrees with respect to a horizontal line of the input image. The object image of 194 can be recognized as an image which is rotated by 180 degrees with respect to the horizontal line of the input image. The rotation reference may be set to the horizontal line of the input image as described above, or may be set to the other object image included in the input image.

As described above, the arrangement rule indicates the relative relationship between the input image and the object image. The arrangement information is information which includes the positional information, size information, rotation information and the like of the object image with respect to the input image. In other words, the arrangement information is classification information which can clearly define the relative relationship between the input image and the object image.

Next, a data structure of the arrangement rule database 146 and the grammatical rule correlated with each piece of the arrangement information will be described in detail with reference to FIG. 6.

The arrangement rule database 146 of FIG. 6 includes an arrangement field and a grammatical rule field. The arrangement rule is described in the arrangement field, such as “upper left region”, “lower right region”, “size”, and “gradient” as shown in the example of FIG. 6. As described above, these items indicate the arrangement information on the object image with respect to the input image, and the grammatical rule is assigned for each pieces of the arrangement information. Referring to the grammatical rule field, “creator”, “date”, “level of importance”, and “degree of satisfaction” is shown as its contents. These contents are examples of the grammatical rules, and are information which can be appropriately set according to the utilization mode of the image interpretation apparatus.

The row in which the arrangement information is “upper left region” and the grammatical rule is “creator” will be specifically described by way of example. The descriptions of the row mean that the grammatical rule of “creator” is applied when the object image is positioned in the “upper left region”. That is, when the image information interpretation section 148 refers to the component database 130 and recognize that a certain object image is positioned in the upper left region of the input image, the image information interpretation section 148 obtains, as the key information, the grammatical rule of“creator” corresponding to the arrangement information of “upper left region” of the arrangement rule database 146. Although only a conceptual description using a key word are shown in FIG. 6, the image information interpretation section 148 can obtain information corresponding to the “creator” field of the component database 130 when obtaining the information on the grammatical rule of“creator”.

Thus, even with the same object image, various semantics can be given according to the position, the size, and the like thereof These various semantics enable wider range in the input image interpretation process or the subsequent-stage process performed subsequent to the input image interpretation process. The input image interpretation procedure will be described in detail below.

(Input Image Interpretation Procedure)

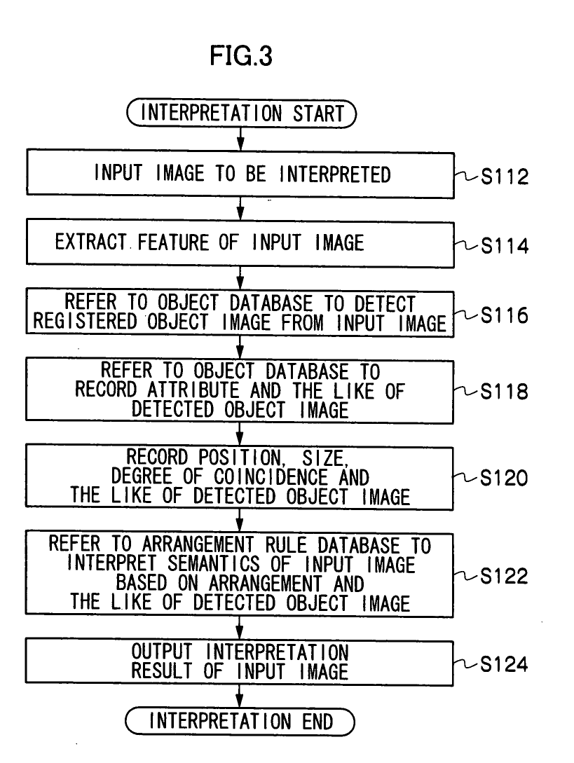

The interpretation procedure in the image processing method of the first embodiment will be described in detail with reference to FIG. 3. FIG. 3 is a flowchart showing the interpretation procedure.

A user inputs an image desired to be interpreted (hereinafter referred to as input image) to the image interpretation apparatus through the image obtaining section 122 (S112). The input image is transmitted from the image obtaining section 122 to the feature extraction section 124, and the image obtaining section 122 extracts at least one feature (S114). Information of the feature is transmitted to the feature comparison section 126 and compared to the feature of the object image registered in the object database 110. Thus the feature comparison section 126 detects the object image included in the input image (S116). At this time, the feature comparison section 126 detects the arrangement information such as the position, size, and degree of coincidence of each object image. Further, the feature comparison section 126 refers to the object database 110 to retrieve the attribute information and the like related with the detected object image, and transmits the attribute information and the arrangement information and the like to the component information storage section 128. The component information storage section 128 registers the received attribute information and arrangement information and the like in the component database 130 (S118 and S120).

When the registration of various pieces of information in the component database 130 is completed, the image information interpretation section 148 interprets the semantics of the input image based on the arrangement information and the like of the detected object image by referring to the arrangement rule database 146 and the component database 130 (S122). At this time, the image information interpretation section 148 collates the arrangement information registered in the component database 130 with the at least one grammatical rule registered in the arrangement rule database 146, and obtains the semantic information corresponding to the arrangement information. Thus the image information interpretation section 148 can retrieve the information registered in the component database 130 based on the semantic information. As a result, the object image included in the input image and the arrangement information of the object image constitute a relationship such as a phrase and grammar in linguistic expression.

When the semantics of the input image is interpreted, the image information interpretation section 148 outputs the interpretation result through the subsequent-stage processing section 160 (S124). For example, the interpretation result may be displayed on a display unit such as a display device, or may be outputted to a print medium via a print unit such as a printer. The interpretation result may also be stored as electronic data in a magnetic storage medium and the like.

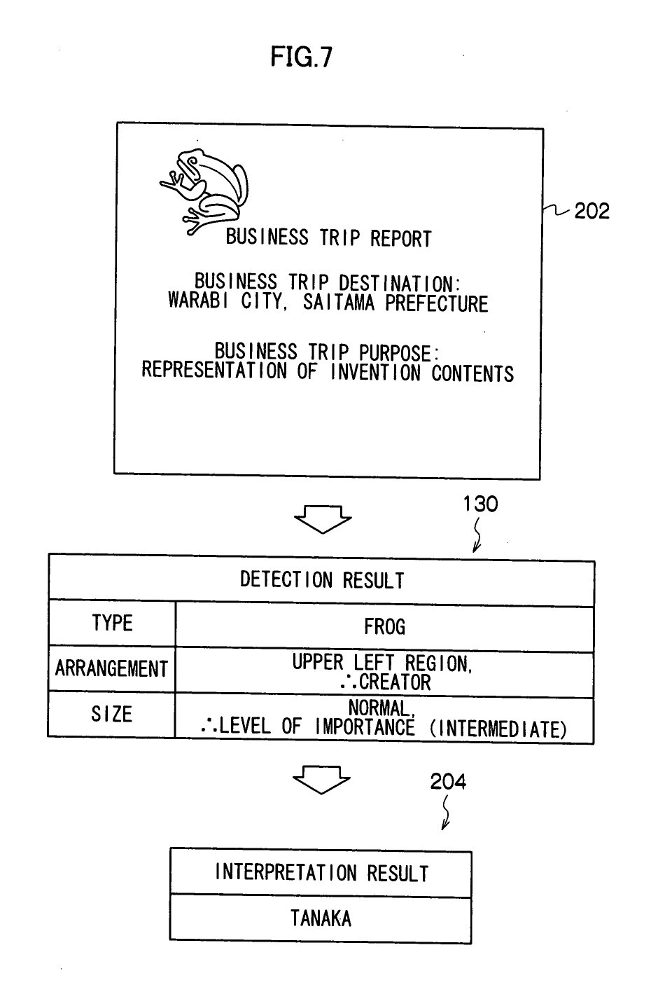

Here, the interpretation procedure will be further described with reference to a specific example shown in FIG. 7. FIG. 7 shows an example for explaining the interpretation procedure, and obviously various configurations can be made according to the registered attribute information, arrangement rules, grammatical rules and the like. FIG. 7 is an explanatory view showing a specific example of the interpretation procedure described above. The explanatory view of FIG. 7 is based on the object database 110 of FIG. 4 and the arrangement rule database 146 of FIG. 6.

FIG. 7 illustrates a business trip report 202 in which the object image indicating the type of “frog” is drawn in “upper left region”, as the input image to which the image interpretation method of the first embodiment is applied.

The image interpretation apparatus obtains the business trip report 202 which is the input image through the image obtaining section 122, and transmits the business trip report 202 to the feature extraction section 124. The feature extraction section 124 extracts a feature from the image of the obtained business trip report 202, and transmits the feature amount obtained by digitizing the feature to the feature comparison section 126. The feature comparison section 126 compares the feature amount registered in the object database 110 with the transmitted feature amount and recognizes that the object image of the type of “frog” is included in the business trip report 202. Further, the feature comparison section 126 detects the arrangement information indicating the position, size, and gradient of the “frog” type object image. Then, the feature comparison section 126 transmits the “frog” type object image and the detected arrangement information to the component database 130. The component information storage section 128 registers, in the component database 130, the “frog” type object image transmitted from the feature comparison section 126, the detected arrangement information, and the attribute information retrieved from the object database 110 based on these pieces of information.

At this time, in the component database 130, at least the type “frog” and the creator of “Tanaka” are registered as the attribute information on the object image included in the business trip report 202, and at least the arrangement of “upper left region” and the size of “normal” are registered as the arrangement information.

When the process of registering the component database 130 is completed, the image information interpretation section 148 retrieves the grammatical rule from the arrangement rule database 146 (see FIG. 6) based on the arrangement information. In this case, the grammatical rule of “creator” is retrieved based on the arrangement of “upper left region” and the grammatical rule of “level of importance” is retrieved based on the arrangement of “size”.

The image information interpretation section 148 interprets that the creator is “Tanaka” based on the grammatical rule of “creator” by referring to the component database 130. The image information interpretation section 148 further interprets that “level of importance” of the business trip report 202 is “middle” because the arrangement of “size” is “normal”. As a result, on the basis of the arrangement information of the object image, the image information interpretation section 148 can interpret the creator of the business trip report 202 as “Tanaka” and the level of importance of the business trip report 202 as “middle”. The interpretation result 204 is transmitted to the subsequent-stage processing section 160 and outputted to the display or the like. In FIG. 7, only the creator is outputted as the interpretation result. However, the level of importance can also be displayed.

Thus, the image interpretation apparatus and image interpretation method of the first embodiment are described. According to the first embodiment, even if a single input image includes only a single object image, different semantics can be expressed by giving the semantics to the arrangement of the object image, thereby the image interpretation can be performed in wider range. Further, the subsequent-stage process can be changed according to the result of the image interpretation.

### Second Embodiment

An image interpretation apparatus and an image interpretation method according to a second embodiment of the invention will be described below. Here, the same components as the first embodiment are designated by the same numerals and the descriptions thereof are omitted, and only the different point is described in detail.

(Configuration of Image Interpretation Apparatus)

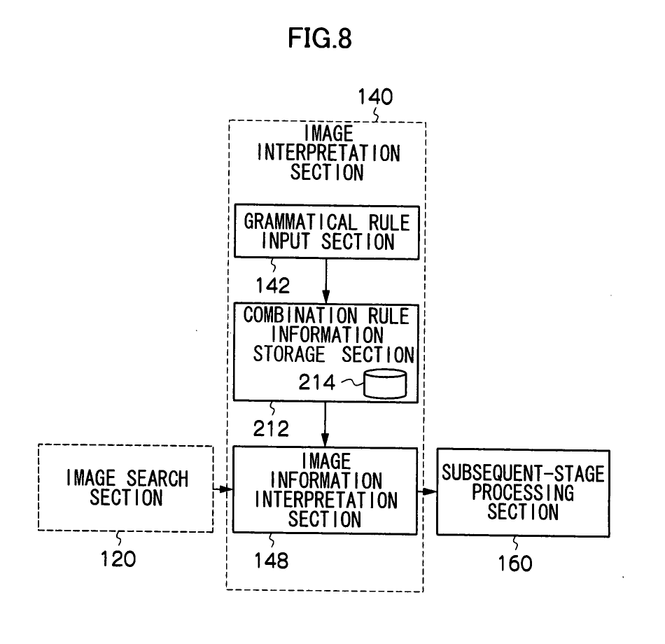

A configuration of the image interpretation apparatus of the second embodiment will be described below with reference to FIG. 8. FIG. 8 is a block diagram showing the configuration of an image interpretation section 140 included in the image interpretation apparatus. As with the image interpretation apparatus of the first embodiment, the image interpretation apparatus includes the registration section 100, the image search section 120, and the subsequent-stage processing section 160. Because the configuration of each section is similar to that of the first embodiment, detailed description thereof is omitted.

(Image Interpretation Section 140)

Referring to FIG. 8, the image interpretation section 140 includes the grammatical rule input section 142, a combination rule information storage section 212, and the image information interpretation section 148.

The grammatical rule input section 142 is an input unit for receiving semantic information to be given to the morphology of an object image included in an input image. Particularly, because the second embodiment is characterized in that the semantics is given to a combination of the object images, the grammatical rule input section 142 is an input unit for inputting semantic information corresponding to the combination of the object images in the input image. The grammatical rule input section 142 may be composed of, for example, a keyboard and a mouse, or may be an apparatus or a program for automatically or manually downloading combination information and semantic information correlated therewith from a database server (not shown) connected to a network.

The combination information is information which indicates a relative positional relationship of plural object images included in the input image. The combination information may include “vertical positional relationship information” indicating whether the object image is positioned in relatively upper position or lower position in the input image, “overlap information” indicating whether or not the plural object images overlap each other, “foreground/background information” indicating whether the overlap object image is in foreground or background, and “magnitude relation information” indicating a relative magnitude relation between the object images. Thus, the rule which defines the semantic information according to the relative morphology of the plural object images is referred to as grammatical rule. When the grammatical rule is inputted, the grammatical rule input section 142 transmits the inputted grammatical rule to the combination rule information storage section 212.

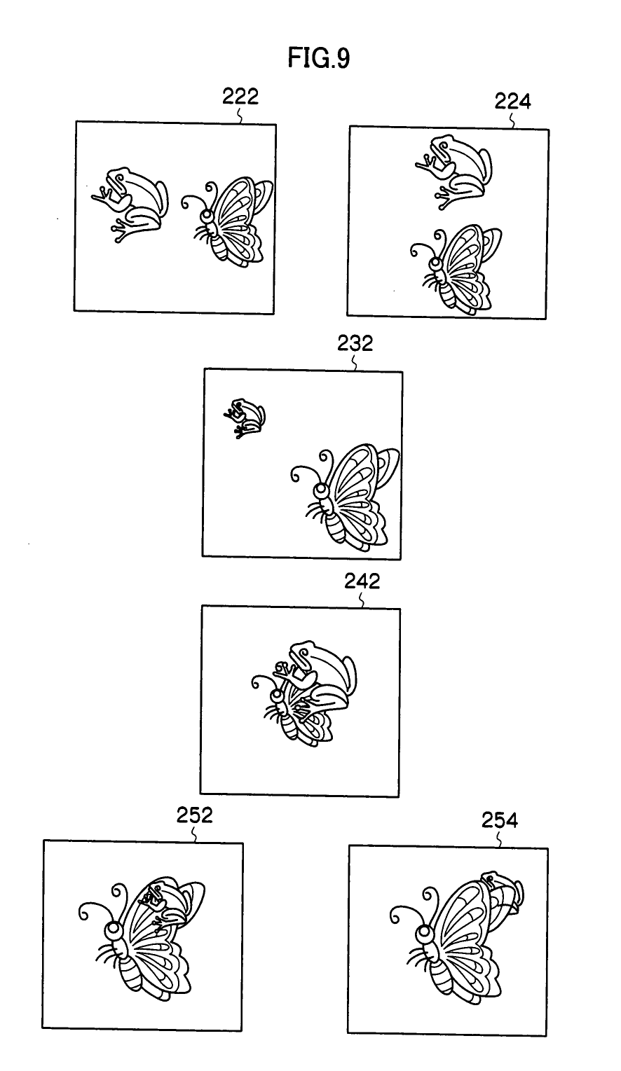

The combination information will specifically be described with reference to FIG. 9. FIG. 9 is an explanatory view showing combinations of the object images.

In FIG. 9, reference numerals 222 and 224 are explanatory views showing the vertical positional relationship of the object images. As clearly seen from the drawing, reference numeral 222 shows the case in which the object image of “frog” is positioned in the left region of the input image while the object image of “butterfly” is positioned in the right region. On the other hand, reference numeral 224 shows the case in which the object image of “frog” is positioned in the upper region of the input image while the object image of “butterfly” is positioned in the lower region. The positional relationship between the object images may be simply a relative relationship, and may be determined based on a position coordinate indicating the center position of each object image. Not only clear horizontal (left/right) and vertical (upper/lower) relationships shown in reference numerals 222 and 224, but also relationships of upper left/lower right, lower left/upper right and the like may be used as the combination information. Further, the combination information may be angle information based on an angle formed between a line segment connecting the centers of the object images and the base of the input image.

Reference numeral 232 in FIG. 9 indicates an explanatory view showing the magnitude relation between the object images. As clearly understood from the drawing, reference numeral 232 shows an image in which the object image of “frog” is smaller than the object image of “butterfly”. The magnitude relation may be determined based on a difference in areas of the object images or an area ratio of the object images. Further, the combination information may be information in which the magnitude relation and the positional relationship are combined.

Reference numeral 242 in FIG. 9 indicates an explanatory view showing the overlap relationship between the object images. The combination information may also be overlap information indicating whether or not plural object images overlap each other as shown by the image of 242. Further, the overlap information may be overlap area information based on an overlap area of the plural object images.

Reference numerals 252 and 254 in FIG. 9 are explanatory views showing foreground/background relationship of the object images. Reference numeral 252 shows a foreground/background relationship in which the object image of “frog” is positioned in the foreground while the object image of “butterfly” is positioned in the background. On the other hand, reference numeral 254 shows a foreground/background relationship in which the object image of “frog” is positioned in the background while the object image of “butterfly” is positioned in the foreground. Thus, the combination information may be foreground/background information indicating the foreground/background relationship of the object images, and the combination information may be information obtained by further combining the above described magnitude relation information and/or the vertical positional relationship information.

As described above, the image interpretation apparatus and image interpretation method of the second embodiment are configured such that the subsequent-stage process can be changed based on the combination information indicating the correlation of the plural object images included in the input image. The combination information may be detected by the feature comparison section 126 included in the image search section 120 and registered in the component database 130. That is, the feature comparison section 126 is one example of the object image extraction section and the combination information obtaining section.

Referring to FIG. 8 again, the combination rule information storage section 212 will be described. The combination rule information storage section 212 includes a combination rule database 214, and registers in the combination rule database 214 the combination information inputted from the grammatical rule input section 142. At this time, the combination rule information storage section 212 registers the combination information in the combination rule database 214 in correlation with the grammatical rule.

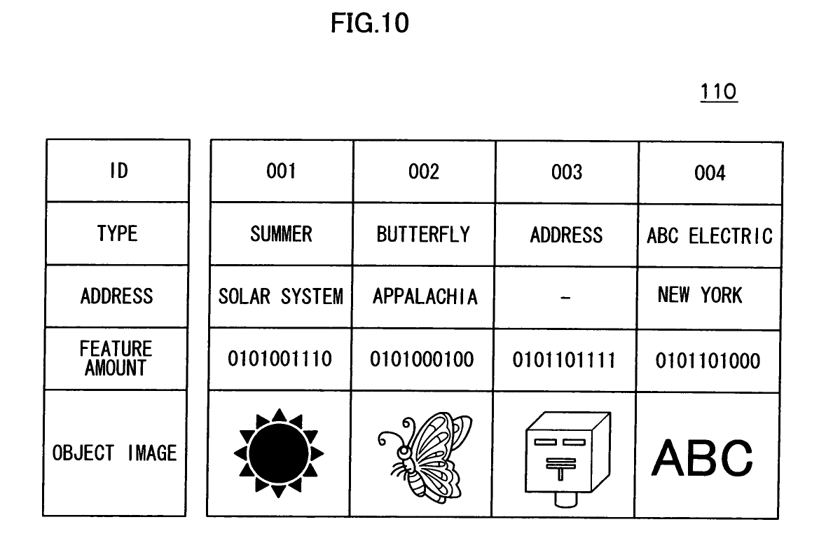

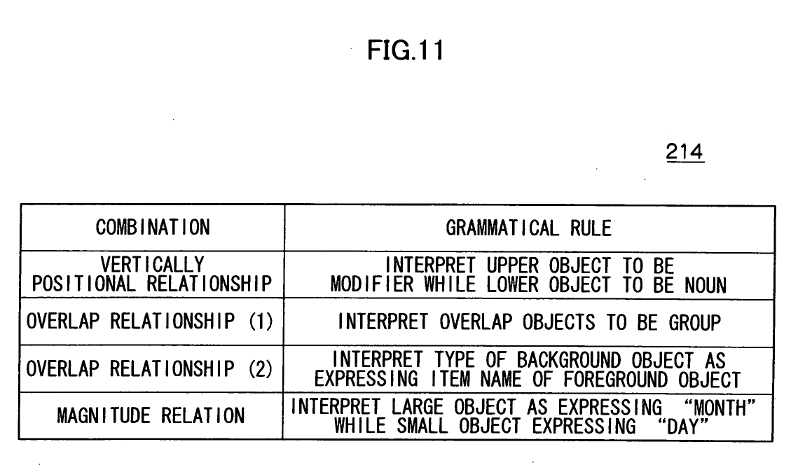

Here, a data configuration of the combination rule database 214 will specifically be described with reference to FIG. 11. FIG. 11 is an explanatory view showing an example of the combination rule database 214 in which the combination information of FIG. 9 is registered in correlation with the grammatical rule. As shown in FIG. 10, it is assumed that four types of the object images, which are correlated with types of “summer”, “butterfly”, “address”, and “ABC electric”, are registered in the object database 110, respectively.

Referring to FIG. 11, “vertical positional relationship”, “overlap relationship (1)”, “overlap relationship (2)”, and “magnitude relation” are registered in a combination field, and the items registered in the combination field are correlated with the grammatical rules described in the grammatical rule field, respectively. For example, when the combination information is “vertical positional relationship”, this “vertical positional relationship” is correlated with the grammatical rule that “an object image positioned in the upper region of the input image is interpreted that it expresses a modifier, and an object image positioned in the lower region is interpreted to be a noun (modified word)”. Similarly, when combination information is “overlap relationship (2)”, this “overlap relationship (2)” is correlated with the grammatical rule that “the type of the object image positioned in the background is interpreted that it expresses the item name of the object image positioned in the foreground”. Specifically, when the object image of the type of “butterfly” is positioned in the foreground and the object image of the type of “address” is positioned in the background, the address “Appalachia” of the type “butterfly” is retrieved based on the combination information of “overlap relationship (2)”.

(Image Interpretation Method)

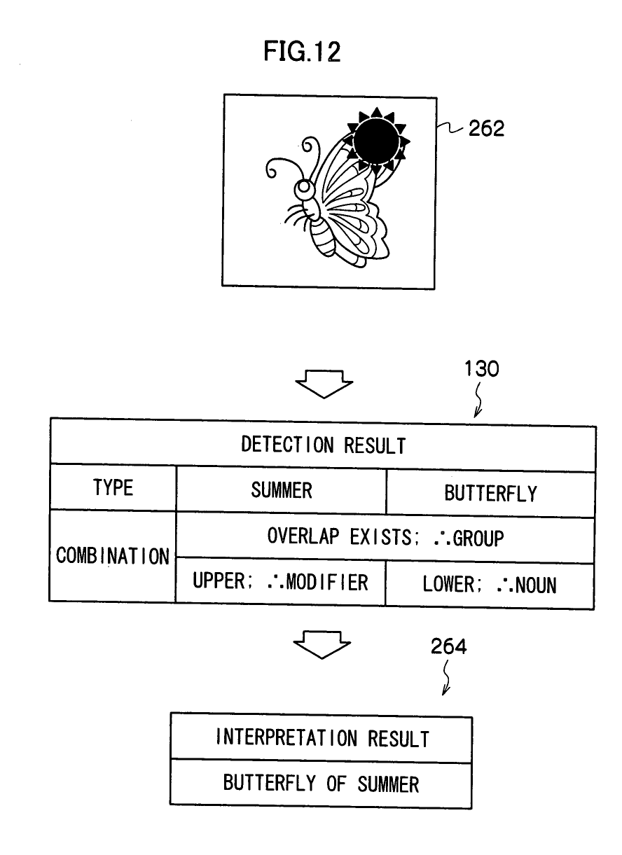

Next, the input image interpretation method performed by the image information interpretation section 148 will be specifically described with reference to FIGS. 12 to 14.

Referring to FIG. 12 firstly, the object image indicating the type “butterfly” and the object image indicating the type “summer” are drawn in an input image 262. Accordingly, the input image 262 is inputted through the image obtaining section 122, and the feature amount of the input image 262 is extracted by the feature extraction section 124. The feature comparison section 126 compares the feature amount registered in the object database 110 of FIG. 10 with the extracted feature amount, and transmits the information on each object image included in the input image 262 to the component information storage section 128. The component information storage section 128 registers in the component database 130 the object image showing the type “butterfly”, the object image showing the type “summer”, the combination information indicating the relative positional relationship of the object images, and the attribute information on each object image.

The image information interpretation section 148 recognizes, by referring to the component database 130, the overlap information indicating that “overlap exists” in the overlap relationship of the object images, and recognizes the vertical positional relationship information indicating that the object image of “summer” is positioned in the upper region while the object image of “butterfly” is positioned in the lower region. Then, the image information interpretation section 148 refers to the combination rule database 214 and recognizes that both of the object images are grouped based on the overlap information (corresponding to “overlap relationship (1)”). Similarly, on the basis of the vertical positional relationship information, the image information interpretation section 148 recognizes a language formation in which “summer” is a modifier and “butterfly” is a noun. As a result, the image information interpretation section 148 can interpret the input image 262 as “butterfly of summer”. The interpretation result is transmitted to the subsequent-stage processing section 160 and outputted to a display or the like.

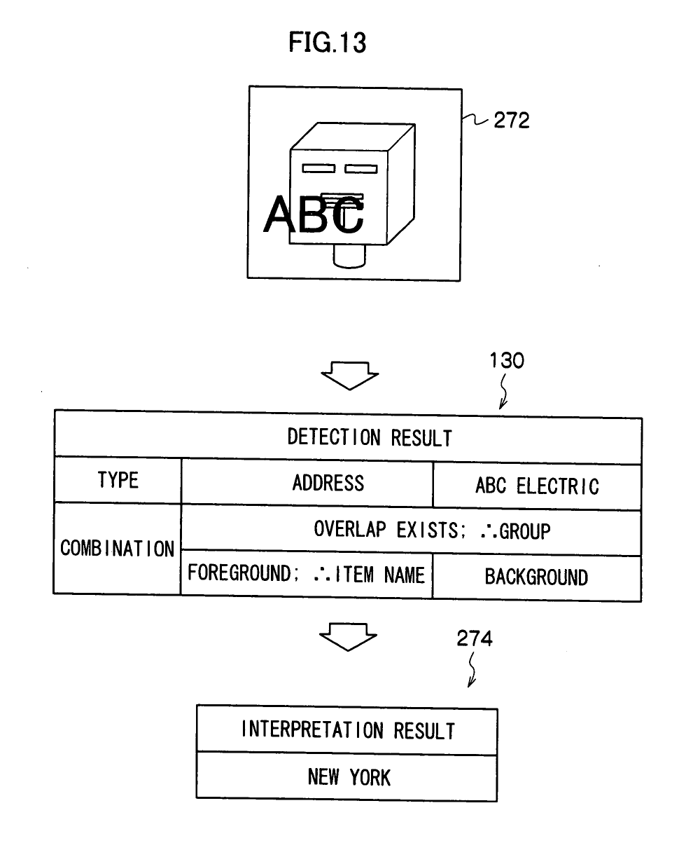

Referring to FIG. 13 next, the object image showing the type of “address” and the object image showing the type of “ABC electric” are drawn in an input image 272. Accordingly, the input image 272 is inputted through the image obtaining section 122, and the feature amount of the input image 272 is extracted by the feature extraction section 124. The feature comparison section 126 compares the feature amount registered in the object database 110 of FIG. 10 with the extracted feature amount, and transmits the information on each object image included in the input image 272 to the component information storage section 128. The component information storage section 128 registers in the component database 130 the object image showing the type of “address”, the object image showing the type of “ABC electric”, the combination information indicating the relative positional relationship of the object images, and the attribute information on each object image.

The image information interpretation section 148 recognizes, by referring to the component database 130, the overlap information indicating that “overlap exists” in the overlap relationship of the object images, and recognizes the foreground/background information indicating that the object image of “ABC electric” is positioned in the foreground while the object image of “address” is positioned in the background. Then, the image information interpretation section 148 refers to the combination rule database 214 and recognizes that both of the object images are grouped based on the overlap information (corresponding to “overlap relationship (1)”). Similarly, on the basis of the foreground/background information, the image information interpretation section 148 recognizes a search condition that “address” is the item name. As a result, the image information interpretation section 148 can interpret the input image 272 as “New York” described in the item “address” of the object image of “ABC electric”. The interpretation result is transmitted to the subsequent-stage processing section 160 and outputted to a display or the like.

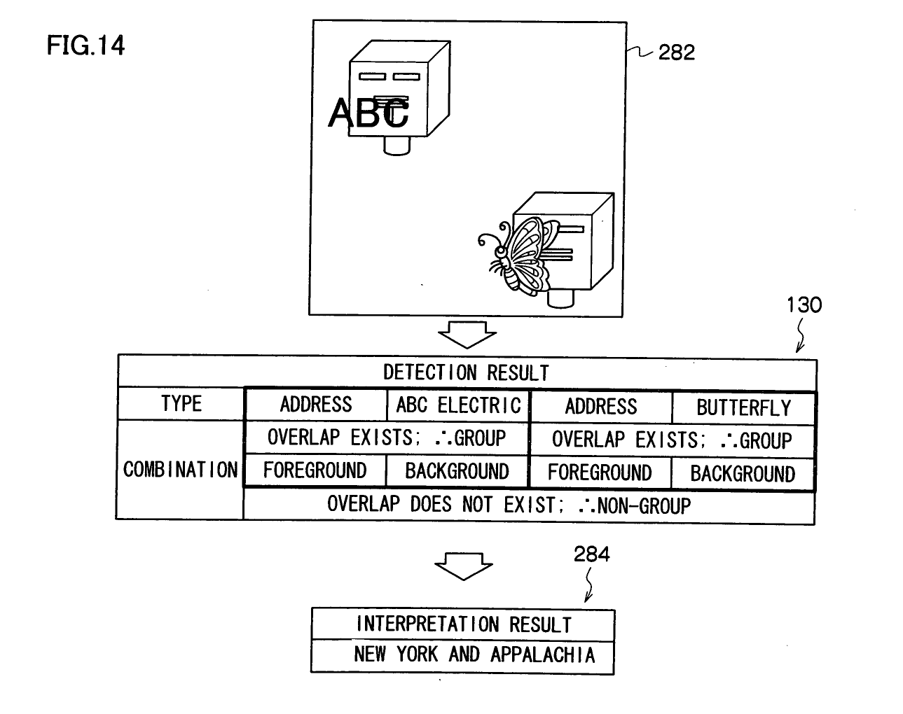

Referring to FIG. 14 next, the two object images showing the type of “address”, the object image showing the type of “ABC electric”, and the object image showing the type of “butterfly” are drawn in an input image 282. Accordingly, the input image 282 is inputted through the image obtaining section 122, and the feature amount of the input image 282 is extracted by the feature extraction section 124. The feature comparison section 126 compares the feature amount registered in the object database 110 of FIG. 10 with the extracted feature amount, and transmits the information on each object image included in the input image 282 to the component information storage section 128. The component information storage section 128 registers in the component database 130 the object images showing the type of “address”, the object image showing the type of “ABC electric”, the object image showing the type of “butterfly”, the combination information indicating the relative positional relationship of the object images, and the attribute information on each object image.

The image information interpretation section 148 obtains from the component database 130 the overlap information indicating that “overlap exists” in the overlap relationship of the object image showing the type of “address” and the object image showing the type of “ABC electric”, and recognizes these object images as a group image (1). The image information interpretation section 148 further obtains from the component database 130 the overlap information indicating that “overlap exists” in the overlap relationship of the object image showing the type of “address” and the object image showing the type of “butterfly”, and recognizes the object images as a group image (2). At the same time, the image information interpretation section 148 obtains the overlap information indicating that “overlap does not exist” in the overlap relationship between the group image (1) and the group image (2). Further, the image information interpretation section 148 obtains the foreground/background information indicating that the object image of “ABC electric” and the object image of “butterfly” are positioned in the foreground while each of the object images of “address” is positioned in the background.

From these pieces of information, the image information interpretation section 148 interprets the group (1) as “New York” and the group (2) as “Appalachia”. The image information interpretation section 148 can interpret the input image 282 as “New York and Appalachia” based on the recognition that the group (1) and the group (2) are not grouped. The interpretation result is transmitted to the subsequent-stage processing section 160 and outputted to a display or the like. Thus, the grammatical rule can also be applied to the object image group which is formed by grouping plural object images.

Thus, the second embodiment of the invention is described in detail. According to the second embodiment, the semantics can be given to the combination of the plural object images included in the input image, so that the number of pieces of semantic information corresponding to the number of combinations of the registered object images can be expressed by the one input image. Accordingly, the interpretation results having more variations can be obtained in the second embodiment compared with the first embodiment as well as a general image interpretation apparatus. Additionally, the second embodiment can perform the subsequent-stage process based on this interpretation result.

### Third Embodiment

An image interpretation apparatus and an image interpretation method according to a third embodiment of the invention will be described below. Here, the same components as the first and second embodiments are designated by the same numerals and the descriptions thereof are omitted, and only the different point is described in detail.

(Configuration of Image Interpretation Apparatus)

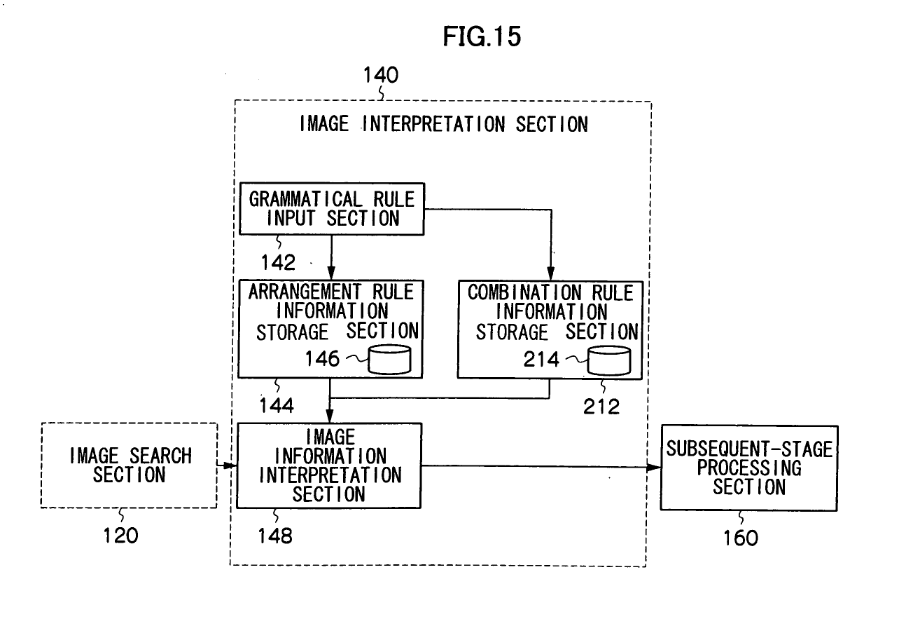

A configuration of the image interpretation apparatus of the third embodiment will be described below with reference to FIG. 15. FIG. 15 is a block diagram showing the configuration of the image interpretation section 140 included in the image interpretation apparatus. As with the image interpretation apparatus of the first embodiment, the image interpretation apparatus includes the registration section 100, the image search section 120, and the subsequent-stage processing section 160. Because the configurations of the sections except for the image interpretation section 140 are similar to those of the first embodiment, detailed descriptions thereof are omitted.

Referring to FIG. 15, the image interpretation section 140 of the third embodiment includes both of the arrangement rule information storage section 144 and the combination rule information storage section 212. The arrangement rule information storage section 144 of the third embodiment has the same configuration as the first embodiment, and includes the arrangement rule database 146. The combination rule information storage section 212 of the third embodiment has the same configuration as the second embodiment, and includes the combination rule database 214.

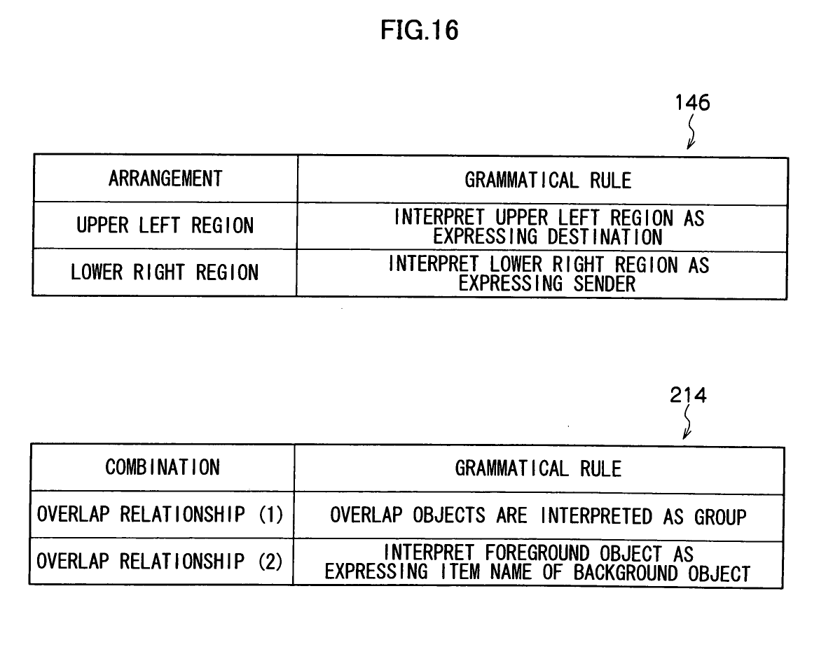

As like the first embodiment, the at least one grammatical rule correlated with the arrangement information is registered in the arrangement rule database 146. For example, as shown by reference numeral 146 of FIG. 16, the arrangement information of “upper left region” and the arrangement information of “lower right region” are registered in correlation with the grammatical rule of “indicating a sender” and the grammatical rule of “indicating a destination”, respectively.

As like the second embodiment, the at least one grammatical rule correlated with combination information is registered in the combination rule database 214. For example, as shown by reference numeral 214 of FIG. 16, the combination information of “overlap relationship (1)” and the combination information of “overlap relationship (2)” are registered in correlation with the grammatical rule of “overlap exists=grouped” and the grammatical rule of “foreground object expresses the item name of the background object”, respectively.

(Image Interpretation Method)

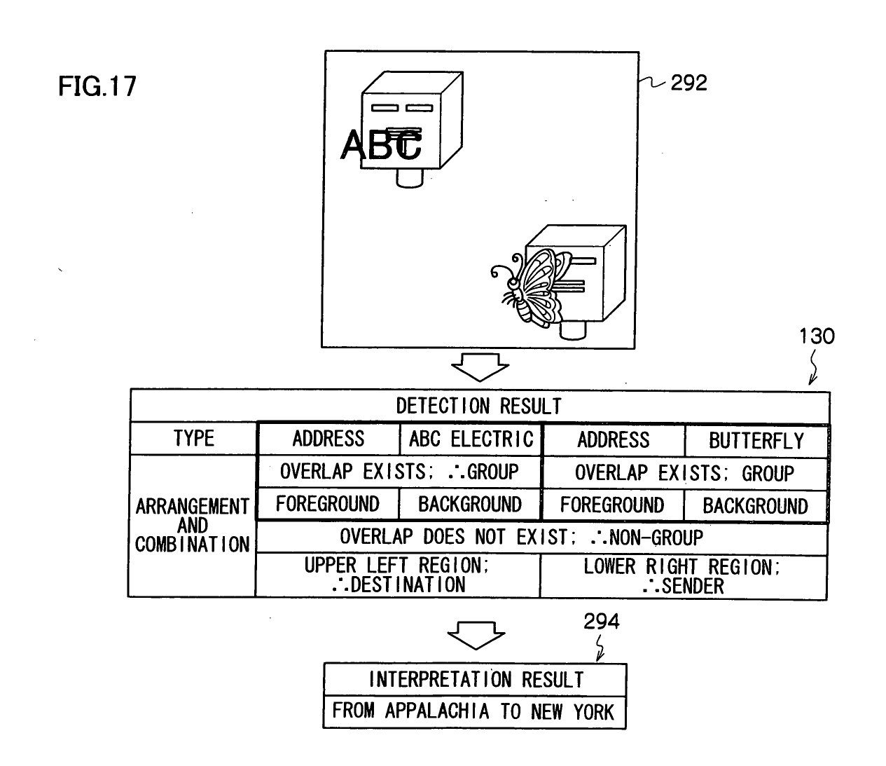

A method of interpreting an input image 292 will be described with reference to a specific example shown in FIG. 17. FIG. 17 is an explanatory view showing the image interpretation method of the third embodiment.

Referring to FIG. 17, the two object images showing the type of “address”, the object image showing the type of “ABC electric”, and the object image showing the type of “butterfly” are drawn in the input image 292. Accordingly, the input image 292 is inputted through the image obtaining section 122, and the feature amount of the input image 292 is extracted by the feature extraction section 124. The feature comparison section 126 compares the feature amount registered in the object database 110 of FIG. 10 to the extracted feature amount, and transmits the information on each object image included in the input image 292 to the component information storage section 128. The component information storage section 128 registers in the component database 130 the object images showing the type of “address”, the object image showing the type of “ABC electric”, the object image showing the type of “butterfly”, the combination information indicating the relative positional relationship among the object images, the arrangement information indicating absolute positional information on each object image, and the attribute information on each object image.

The image information interpretation section 148 first obtains, from the component database 130, the overlap information indicating that “overlap exists” in the overlap relationship between the object image showing the type of “address” and the object image showing the type of “ABC electric”, and recognizes these object images as a group image (1). The image information interpretation section 148 further obtains, from the component database 130, the overlap information indicating that “overlap exists” in the overlap relationship between the object image showing the type of“address” and the object image showing the type of “butterfly”, and recognizes these object images as a group image (2). At the same time, the image information interpretation section 148 obtains the overlap information indicating that “overlap does not exist” in the overlap relationship between the group image (1) and the group image (2). The image information interpretation section 148 further obtains the foreground/background information indicating that the object image of “ABC electric” and the object image of “butterfly” are positioned in the foreground while each of the object images of “address” are positioned in the background. The image information interpretation section 148 obtains the arrangement information indicating that the group image (1) is positioned in the upper left region of the input image 292 while the group image (2) is positioned in the upper right region.

The image information interpretation section 148 refers to the combination rule database 214, interprets the group (1) as “New York” and interprets the group (2) as “Appalachia”. The image information interpretation section 148 further interprets the group (1) and the group (2) as not grouped. The image information interpretation section 148 refers to the arrangement rule database 146 and interprets “New York” which is of the semantics of the group image (1) and “Appalachia” which is of the semantics of the group image (2) as “destination” and “sender”, respectively. As a result, the image information interpretation section 148 interprets the input image 292 as “from Appalachia to New York”. The interpretation result is transmitted to the subsequent-stage processing section 160 and outputted to a display or the like.

Thus, the third embodiment of the invention is described above. According to the third embodiment, the semantics can be given according to the positional information and the combination information on the object images, and the third embodiment can deal with the subsequent-stage process having more variations compared with the first and second embodiments.

### Fourth Embodiment

An image interpretation apparatus and an image interpretation method according to a fourth embodiment of the invention will be described below. Here, the same components as the first, second, and third embodiment are designated by the same numerals and the descriptions thereof are omitted, and only the different point is described in detail.

(Configuration of Image Interpretation Apparatus)

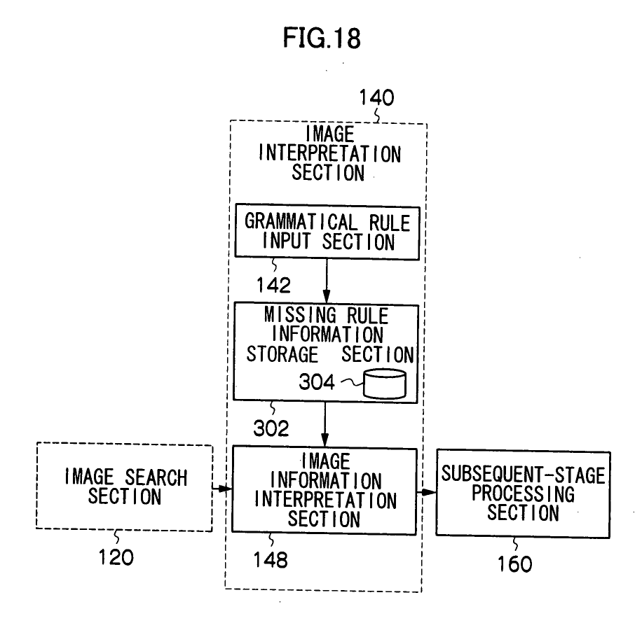

A configuration of the image interpretation apparatus of the fourth embodiment will be described below with reference to FIG. 18. FIG. 18 is a block diagram showing the configuration of an image interpretation section 140 included in the image interpretation apparatus of the fourth embodiment. As like the image interpretation apparatus of the first embodiment, the image interpretation apparatus includes the registration section 100, the image search section 120, and the subsequent-stage processing section 160. Because the configurations of the sections except for the image interpretation section 140 are similar to those of the first embodiment, detailed descriptions thereof are omitted.

(Image Interpretation Section 140)

Referring to FIG. 18, the image interpretation section 140 includes the grammatical rule input section 142, a missing rule information storage section 302, and the image information interpretation section 148.

The grammatical rule input section 142 is an input unit which receives the semantic information to be given to the morphology of the object image included in the input image. Particularly, the fourth embodiment is characterized in that the semantics is given to missing information on the object image. Therefore, the grammatical rule input section 142 is an input unit for inputting the semantic information corresponding to the missing information on the object image in the input image. The grammatical rule input section 142 may be composed of, for example, a keyboard, a mouse and the like.

The missing information includes, for example, missing area information indicating a missing area where a part of the object image is blacked, missing area information indicating a percentage of a missing area to the area of the object image, missing area information indicating a missing area which is painted a color other than black, missing area information indicating an area where a part or the whole of the object image is simply distinguishably partitioned by other colors. The missing information may also be missing positional information indicating a position of a missing region in the input image.

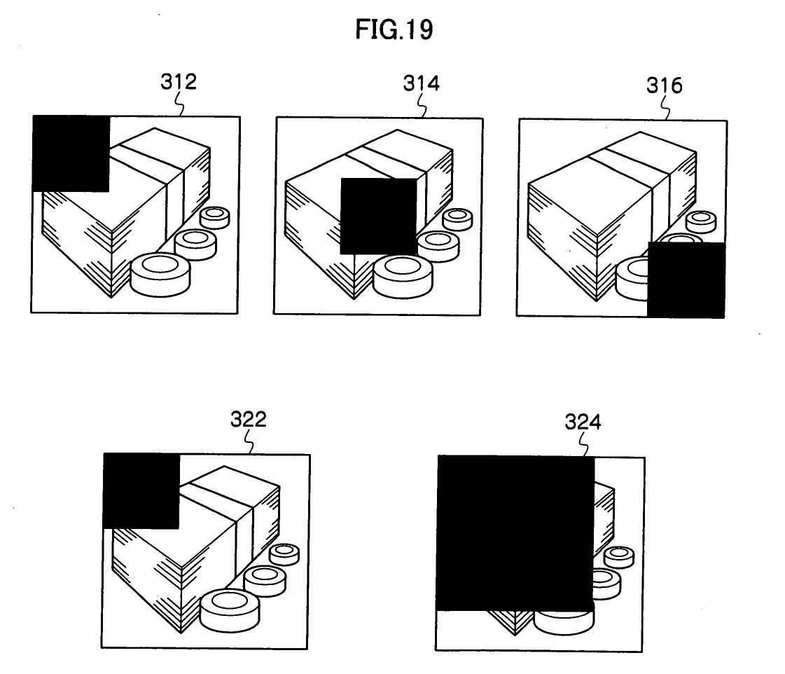

The missing information will specifically be described with reference to FIG. 19. FIG. 19 is an explanatory view showing missing examples of the object image.

In FIG. 19, reference numerals 312, 314, and 316 indicates explanatory views showing three variations for the missing positional information. Referring to FIG. 19, the missing regions are illustrated so as to be positioned in the upper left region (reference numeral 312), central region (reference numeral 314), and lower right region (reference numeral 316) of the object image. Obviously, the missing region may be positioned in another region. For example, any position can be recognized when the position is specified by position coordinates based on the center of the input image or the object image.

Reference numerals 322 and 324 in FIG. 19 are explanatory views showing two variations for the missing area information. Referring to FIG. 19, the missing area shown by 322 is drawn smaller than the missing area shown by 324. Thus, the missing area information may be information indicating the magnitude relation of the relative missing areas. The missing area in 322 of FIG. 19 represents about 30% of the object image. On the other hand, the missing area in 324 of FIG. 19 represents about 80% of the object image. Thus, the missing area information may be an area ratio of the missing region with respect to the area of the object image. The missing region can be determined by a mismatch rate with the registered object image detected by the feature comparison section 126. That is, the feature comparison section 126 is one example of the missing information obtaining section.

(Missing Rule Database 304)

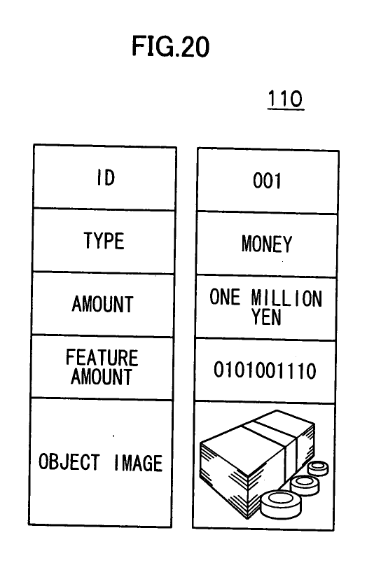

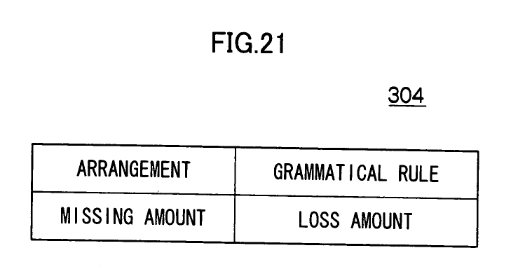

A configuration of the missing rule database 304 included in the missing rule information storage section 302 will be described with reference to FIG. 21. Prior to the description of the configuration of the missing rule database 304, a configuration of the object database 110 of the fourth embodiment will be specifically described with reference to FIG. 20.

Referring to FIG. 20, an object image of “money” is registered as an example of the object database 110. The type of “money”, an amount of “one million yen”, and the feature amount are registered as the attribute information on the object image. At this point, the amount of “one million yen” should be noted. That is, when the object image of “money” is not missed at all, the semantic information indicating the amount of “one million yen” is correlated with the object image.

Referring to the missing rule database 304 of FIG. 21 in consideration of the object database 110, the arrangement information of “missing amount” and the grammatical rule of “loss amount” are registered in correlation with each other. That is, the missing rule database 304 gives the grammatical rule that the missing amount (for example, the missing area) of the object image is interpreted as a loss of “amount” assigned to the object image.

(Image Information Interpretation Section 148)

The image information interpretation section 148 refers to the component database 130 in which the object image extracted from the input image, the attribute information, the arrangement information and the like are registered, and further refers to the missing rule database 304 to interpret the semantics of the input image.

(Image Interpretation Method)

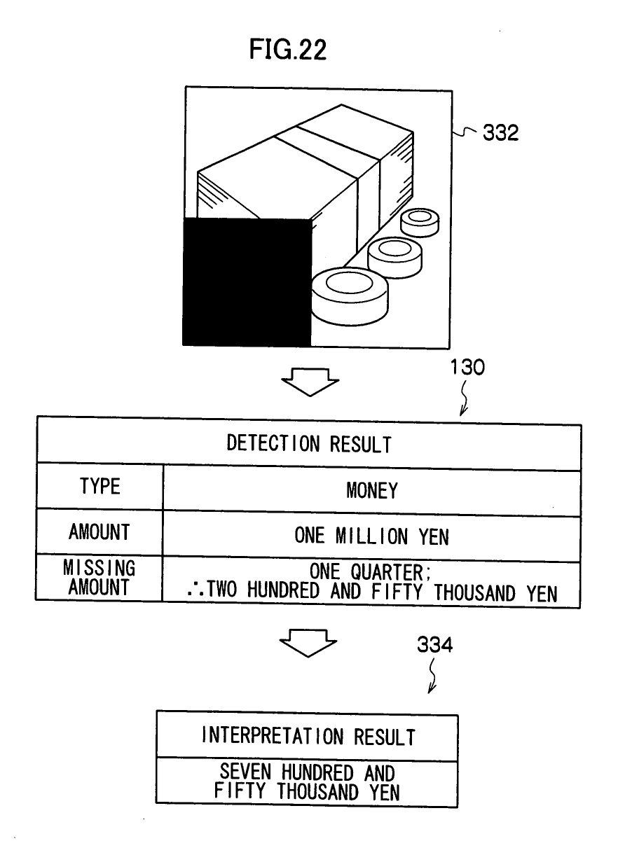

The method of interpreting an input image 332 will be described with reference to a specific example shown in FIG. 22. FIG. 22 is an explanatory view showing the image interpretation method of the fourth embodiment.

Referring to the input image 332, the object image showing the type of “money” is drawn, and a part of the lower left region of the object image is hidden behind a black rectangular region. The area of the hidden black region which is the missing region occupies for a quarter of the object image.

The image information interpretation section 148 refers to the component database 130 and recognizes that the object image showing the type of “money” is included in the input image 332 and the object image has the semantics of the amount of “one million yen”. On the basis of the arrangement information registered in the component database 130, the image information interpretation section 148 recognizes that the missing amount of the object image is a quarter. Then, the image information interpretation section 148 refers to the missing rule database 304 and recognizes that the missing amount has the semantics of “loss amount”, and interprets the “loss amount” of the amount of “one million yen” of the object image as two hundred and fifty thousand yen. As a result, the image information interpretation section 148 interprets the semantics of the input image 332 as “seven hundred and fifty thousand yen” (the quarter (two hundred and fifty thousand yen) of one million yen is lost). The interpretation result is transmitted to the subsequent-stage processing section 160 and outputted to a display or the like.

Thus, the image interpretation apparatus and image interpretation method of the fourth embodiment are described. According to the fourth embodiment, the semantics can be given to the missing state (hidden state) of the object image, and various pieces of semantics can be given to the input image by performing a simple operation of painting out the object image.

Although the exemplary embodiments of the present invention are described above with reference to the accompanying drawings, obviously the invention is not limited to the above embodiments. It should be understood that various changes and modifications can be made by a person skilled in the art without departing from the scope of the invention, and these changes and modifications are of course be included in the scope of the invention.

For example, in the above embodiments, the feature extraction section 104 included in the registration section 100 and the feature extraction section 124 included in the image search section 120 are described such that they are implemented in a same device. However, these may be separate sections having different functions and configurations in order to detect from the input image the object image arranged in different size and/or position from those of the registered object image.

Further, the above embodiments are described as directed to digital-format contents. However, the invention is not limited to the digital-format contents, and can also be applied to analog-format contents (such as a picture drawn in a paper or a whiteboard etc., and/or a photograph).

What is claimed is:

1. An image interpretation apparatus comprising:
a registration image information storage section which includes an object database in which an object image expressing a single object, at least one feature being able to specify a type of the object image, and semantic information corresponding to the object image are registered in correlation with one another;
an image obtaining section which obtains an input image to be a subject of interpretation of semantics;
an object image extraction section which scans the input image to detect its features, and extracts the registered object image included in the input image and the semantic information corresponding to the object image;
an arrangement information obtaining section which obtains arrangement information indicating a relationship between the input image and the object image;
a grammatical rule information storage section which includes a grammatical rule database in which at least one grammatical rule is registered for adding additional semantics to the input image corresponding to the relationship between the input image and the object image; and
an image interpretation section which retrieves the at least one grammatical rule based on the arrangement information, and interprets the semantics of the input image based on the semantic information on the object image and the at least one grammatical rule.

2. The image interpretation apparatus of claim 1, wherein:
the arrangement information includes positional information indicating a position of each object image in the input image;
the at least one grammatical rule is a rule for selecting a single piece of semantic information from the semantic information corresponding to the object image, according to the positional information; and
the image interpretation section interprets the semantic information of the object image selected according to the at least one grammatical rule, as the semantics of the input image.

3. The image interpretation apparatus of claim 1, wherein:
the arrangement information includes morphological information on a size and/or a gradient of the object image;
the at least one grammatical rule defines a method of computing an evaluation value, the parameters of which are based on the morphological information; and
the image interpretation section interprets the semantics of the input image by adding the evaluation value computed according to the at least one grammatical rule.

4. The image interpretation apparatus of claim 1, wherein:
the arrangement information obtaining section comprises a combination information obtaining section which, when a plurality of object images are extracted by the object image extraction section, further obtains combination information indicating a relationship between one of the extracted object images and the other extracted object images;
the grammatical rule information storage section comprises a combination rule information storage section which includes a combination rule database in which at least one grammatical rule is registered for adding additional semantics to the input image corresponding to the relationship between the object images; and
the image interpretation section retrieves the at least one grammatical rule based on the arrangement information and the combination information, and interprets the semantics of the input image based on the semantic information of the object image and the at least one grammatical rule.

5. The image interpretation apparatus of claim 1, wherein:
the arrangement information includes at least one of:
(a) positional information indicating a position of each object image in the input image;
(b) combination information indicating, when a plurality of object images are extracted, a relationship between one of the extracted object images and the other extracted object images; or
(c) missing information on a missing region of the extracted object image.

6. The image interpretation apparatus of claim 4, wherein:
the combination information includes positional information indicating a relative positional relationship of the plurality of extracted object images;
the at least one grammatical rule defines a joining relationship of the semantic information corresponding to each object image according to the positional information; and
the image interpretation section interprets the semantic information on the plurality of object images, which are joined according to the at least one grammatical rule, as the semantics of the input image.

7. The image interpretation apparatus of claim 1, wherein:
the arrangement information obtaining section comprises a missing information obtaining section which detects missing information on a missing region of the extracted object image;
the grammatical rule information storage section comprises a missing rule information storage section which includes a combination rule database in which at least one grammatical rule is registered for adding additional semantics to the input image based on a missing percentage of the object images; and
the image interpretation section retrieves the at least one grammatical rule based on the missing information, and interprets the semantics of the input image based on the semantic information on the object image and the at least one grammatical rule.

8. The image interpretation apparatus of claim 7, wherein:
the missing information includes missing area information indicating an area ratio of an area of the detected missing region to an area of the object image;
the at least one grammatical rule defines a computation method in which a quantitative value included in the semantic information corresponding to the object image is changed according to the area ratio; and
the image interpretation section interprets a quantitative value of the object image, which is computed according to the at least one grammatical rule, as the semantics of the input image.

9. An image interpretation method comprising:
registering an object image expressing a single object, at least one feature being able to specify a type of the object image, and semantic information corresponding to the object image in an object database, wherein the object image, the at least one feature, and the semantic information are correlated with one another;
obtaining an input image to be a subject for interpretation of semantics;
scanning the input image to detect its features, and extracting the registered object image included in the input image and the semantic information corresponding to the object image;
obtaining arrangement information indicating a relationship between the input image and the object image;
registering in an arrangement rule database at least one grammatical rule for adding additional semantics to the input image, corresponding to the relationship between the input image and the object image; and
retrieving the at least one grammatical rule based on the arrangement information, and interpreting the semantics of the input image based on the semantic information on the object image and the at least one grammatical rule.

10. The image interpretation method of claim 9, further comprising:
extracting a plurality of registered object images included in the input image, and the semantic information corresponding to the object images;
obtaining combination information indicating a relationship between one of the extracted object images and the other extracted object images;
registering in a combination rule database at least one grammatical rule for adding additional semantics to the input image, corresponding to the relationship between the object images; and
retrieving the at least one grammatical rule based on the combination information, and interpreting the semantics of the input image based on the semantic information on the object image and the at least one grammatical rule.

11. The image interpretation method of claim 9, further comprising:
detecting missing information on a missing region of the extracted object image;
registering in a combination rule database at least one grammatical rule for adding additional semantics to the input image, corresponding to a missing percentage of the object image; and
retrieving the at least one grammatical rule based on the missing information, and interpreting the semantics of the input image based on the semantic information on the object image and the at least one grammatical rule.

12. A machine-readable storage medium storing a program for causing a computer to execute an image interpretation process, the process comprising:
registering an object image expressing a single object, at least one feature being able to specify a type of the object image, and semantic information corresponding to the object image in an object database, wherein the object image, the at least one feature, and the semantic information are correlated with one another;
obtaining an input image to be a subject for interpretation of semantics;
scanning the input image to detect its features, and extracting the registered object image included in the input image and the semantic information corresponding to the object image;
obtaining arrangement information indicating a relationship between the input image and the object image;
registering in an arrangement rule database at least one grammatical rule for adding additional semantics to the input image, corresponding to the relationship between the input image and the object image; and
retrieving the at least one grammatical rule based on the arrangement information, and interpreting the semantics of the input image based on the semantic information on the object image and the at least one grammatical rule.

13. The machine-readable storage medium of claim 12, the process further comprising:
scanning the input image to detect its features, and extracting a plurality of registered object images included in the input image and the semantic information corresponding to the object images;
obtaining combination information indicating a relationship between one of the extracted input images and the other extracted object images;
registering in a combination rule database at least one grammatical rule for adding additional semantics to the input image, corresponding to the relationship between the object images; and
retrieving the at least one grammatical rule based on the combination information, and interpreting the semantics of the input image based on the semantic information on the object image and the at least one grammatical rule.

14. The machine-readable storage medium of claim 12, the process further comprising:
detecting missing information on a missing region of the extracted object image;
registering in a combination rule database at least one grammatical rule for adding additional semantics to the input image, corresponding to a missing percentage of the object image; and
retrieving the at least one grammatical rule based on the missing information, and interpreting the semantics of the input image based on the semantic information on the object image and the at least one grammatical rule.
